(19) United States
(12) Patent Application Publication
(10) Pub. No.: US 2018/0010938 A1
(43) Pub. Date: Jan. 11, 2018

(54) METHOD AND APPARATUS FOR MONITORING CONSUMPTION OF FLOWING SUBSTANCE

(71) Applicant: Streamsave Oy, Oulunsalo (FI)

(72) Inventor: Teppo SYRJALA, Oulunsalo (FI)

(21) Appl. No.: 15/483,222

(22) Filed: Apr. 10, 2017

(30) Foreign Application Priority Data
Jul. 8, 2016 (FI) 20165569

(51) Int. Cl. G01F 1/56; G06Q 30/02; G01R 21/133; G01K 1/14; E03C 1/04; G06Q 20/14; G06Q 50/12

(52) U.S. Cl. CPC G01F 1/56; G01K 1/14; G06Q 30/02; E03C 1/0408; G01R 21/133; G06Q 50/12; G06Q 20/145

(57) ABSTRACT

An apparatus for monitoring consumption of flowing substance is provided. The apparatus, connectable to the end of a pipe where fluid is flowing, includes a generator (106) configured to generate electric power from the fluid passing through the generator, sensors (112, 114) to measure the temperature of the fluid and the amount of fluid flowing in the pipe and a processing unit (116). The apparatus detects that fluid starts flowing in the pipe at a first time instant and detects that fluid stops flowing in the pipe at a second time instant and determines the temperature of the fluid and the amount of fluid that flowed through the pipe between the first and the second time instant, stores the determined values and the time elapsed between the first and the second time instants as an entry in a memory (120); and transmits the entry.

### TECHNICAL FIELD

The exemplary and non-limiting embodiments of the invention relate generally to monitoring consumption of fluid substance, such as water.

### BACKGROUND

Water, especially fresh or potable water is a limited resource in many places around the world. Even if water is readily available heating water for example for showering takes a lot of energy. It has been estimated that showering with warm water is one of the main contributors for water and energy consumption. Even small reductions in consumption may lead to considerable savings in a household. However, it is difficult to monitor the consumption while in the shower.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to an aspect of the present invention, there is provided an apparatus connectable to the end of a pipe where water is flowing, the apparatus comprising: a generator configured to generate electric power from the water passing through the generator and means for storing electricity generated by the generator, a first sensor configured to measure the temperature of the water, a processing unit and a memory operationally connected to the processing unit; a wireless transceiver operationally connected to the processing unit; wherein the processing unit is configured to receive power from the generator; and the processing unit is configured to detect that water starts flowing in the pipe at a first time instant on the basis of signal from the generator; initiate after the detection reception from the first sensor information on the temperature of the water, determination of the amount of water flowing in the pipe from the amount of electricity generated by the generator, and measurement of time elapsed since the first time instant; detect that fluid stops flowing in the pipe at a second time instant on the basis of lack of signal from the generator; calculate the total amount of fluid that flowed through the pipe between the first and the second time instant; determine the temperature of the fluid between the first and the second time instant; store the determined values and the time elapsed between the first and the second time instants as an entry in the memory; control the transceiver to communicate with other corresponding apparatuses for exchanging information about the used amount of warm water; and control the transceiver to transmit the entry to an external device.

According to an aspect of the present invention, there is provided an apparatus, comprising: at least one processor; and at least one memory including computer program code, the at least one memory and the computer program code configured to, with the at least one processor, cause the apparatus at least to perform: control a transceiver to receive one or more entries, each entry comprising a time interval, an amount of water associated with the time interval and a temperature associated with the fluid; store the received one or more entries in the memory; determine the location of the apparatus based on a satellite positioning receiver and transmit information on the location to a network server; receive from the network server location based information related to the properties and pricing information of the fluid and energy consumption; and calculate for one or more entries an energy and/or price information value on the basis of a received and obtained information.

According to an aspect of the present invention, there are provided a method for determining water consumption of water flowing through a pipe, the method comprising: generating electric power with a generator connected to the pipe from water passing through the generator and storing the electricity, measuring the temperature of the water with a first sensor, detecting that water starts flowing in the pipe at a first time instant on the basis of signal from the generator; measuring the amount of water flowing in the pipe based on the amount of electricity generated by the generator; measuring time elapsed since the water started continuously flowing through the pipe; detecting that water stops flowing in the pipe at a second time instant on the basis of lack of signal from the generator; determining the amount of water that flowed through the pipe between the first and the second time instant; determining the temperature of the water between the first and the second time instant; storing the determined values and the time elapsed between the first and the second time instants as an entry in a memory; controlling the transceiver to communicate with other corresponding apparatuses for exchanging information about the used amount of warm water; and controlling a transceiver to transmit the entry to an external device.

According to an aspect of the present invention, there are provided a method comprising: receiving with a transceiver one or more entries, each entry comprising a time interval, an amount of water associated with the time interval and a temperature associated with the water; storing the received one or more entries in a memory, determining the location of the apparatus based on a satellite positioning receiver and transmit information on the location to a network server; receiving from the network server location based information related to the properties and pricing information of the water and energy consumption, and calculating for one or more entries an energy and/or price information value on the basis of a received and obtained information.

Some embodiments of the invention are disclosed in the dependent claims.

### BRIEF DESCRIPTION OF THE DRAWINGS

In the following the invention will be described in greater detail by means of preferred embodiments with reference to the attached drawings, in which

FIG. 1 illustrates a simplified example of an apparatus of an embodiment;

FIG. 2 is a flowchart illustrating an embodiment;

FIG. 3 illustrates an example of the use of indicators;

FIG. 4 illustrates an example of a communication environment of the apparatus;

FIG. 5 is a flowchart illustrating an example of the communication of an external device with the apparatus of an embodiment;

FIG. 6 is a flowchart illustrating an example of communication of an external device with a server;

FIG. 7 illustrates a simplified example of an apparatus of an embodiment.

### DETAILED DESCRIPTION OF SOME EMBODIMENTS

Some exemplary embodiments of the present invention will now be described more fully hereinafter with reference to the accompanying drawings. The invention may be embodied in many different forms and should not be construed as limited to the embodiments set forth herein. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

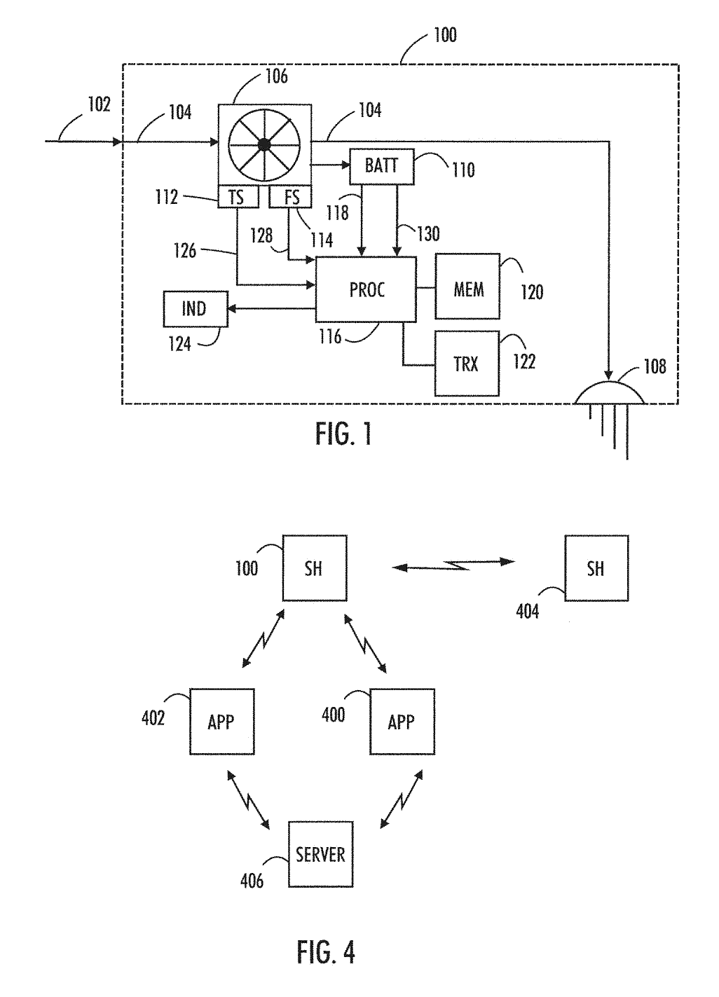

FIG. 1 is illustrates an example of an apparatus 100 for monitoring consumption of flowing matter substance such as water. The apparatus may be installed at the end of a pipe 102 where fluid is flowing. In an embodiment, the apparatus is removably connected to a pipe 102 of a shower in the place of a regular shower head. The pipe 102 may be of flexible material. In the following non-limiting examples the fluid is assumed to be water.

In an embodiment, the apparatus comprises a standard connector used in shower heads. The apparatus may be connected in the place of a regular shower head and it may be visually similar to a regular shower head.

The apparatus comprises a generator 106 configured to generate electric power from the water passing 104 through the generator. In an embodiment, when the apparatus is replacing a regular shower head, the water coming from the pipe 102 is led 104 via the generator 106 to a nozzle 108.

In an embodiment, the generator stores the generated power into a battery 110. The battery may be realised with various means known in the art. For example, one or more capacitors may be used. The battery may provide the apparatus energy when the generator is not generating energy.

The apparatus comprises a processing unit 116. The processing unit is configured to receive power from the generator 106 either directly or 118 via the battery 110. A memory 120 may be operationally connected to the processing unit. The memory may store software and data for the use of the processing unit, for example. In an embodiment, the processing unit may configured to receive 130 from the battery information on the available power stored in the battery and control the operation of the apparatus on the basis of the information.

The apparatus may comprise a first sensor 112 configured to measure the temperature of the water coming from the pipe 102 and flowing through the apparatus. The first sensor may be connected 126 to the processing unit 116.

The apparatus may further comprise a second sensor 114 configured to measure the amount of water coming from the pipe 102 and flowing through the apparatus. The second sensor may be connected 128 to the processing unit 116. In an embodiment, the sensors 112, 114 or one of them is integrated with the generator. For example, the second sensor measuring the amount of water may be realised with the generator by estimating the amount of water from the electricity generated by the generator.

The apparatus comprises a wireless transceiver 122 operationally connected to the processing unit 116. The wireless transceiver 122 may be a Bluetooth® transceiver or a Wireless Local Area Network (WLAN) transceiver based on IEEE 802.11 standard, for example. IEEE refers to the Institute of Electrical and Electronics Engineers. Bluetooth® and WLAN are merely illustrative examples as any other transmission technology may also be used as well.

The apparatus may further comprise a set of indicators 124. The indicators may be LEDs (light emitting diodes), other visible indicators such as a display, a vibrating unit or a speaker, for example.

It may be noted that although the apparatus is described above as a replacement for a shower head it is not limited to that example. The apparatus may be used to monitor water usage in different applications such as water taps and also for monitoring different fluids such as gasoline or gas, for example.

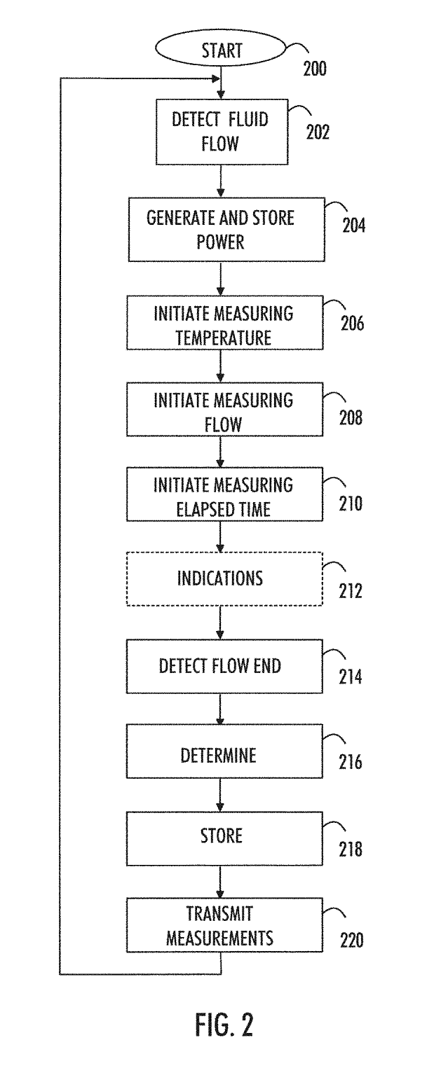

FIG. 2 is a flowchart illustrating an embodiment of the operation of the apparatus. The process starts at step 200.

In step 202, the apparatus is configured to detect that fluid starts flowing in the pipe at a first time instant. When the water starts flowing in the pipe 102 due to a user operation, for example, the water enters the apparatus and starts flowing through the generator 104.

In step 204, the generator starts storing power to the battery 106 which feeds the processing unit 106. The processing unit may be in a sleep state or in off state when the water is not flowing but it may be woken up or switched to on state when the water starts flowing. The processing unit may woke up as a response to the power received from the generator via the battery, for example. The signal from the transceiver may also wake the unit.

In step 206, the apparatus is configured to start measuring of the temperature of the water flowing in the pipe. The measurement is performed by the first sensor 112 and processing unit receives and controls the measurement.

In step 208, typically simultaneously with step 206, the apparatus is configured to start measuring of the amount of water flowing in the pipe. The measurement is performed by the second sensor 114 and processing unit receives and controls the measurement.

In step 210, the apparatus is configured to initiate measurement of time elapsed since the first time instant. Processing unit may initiate a timer to measure the elapsed time, for example.

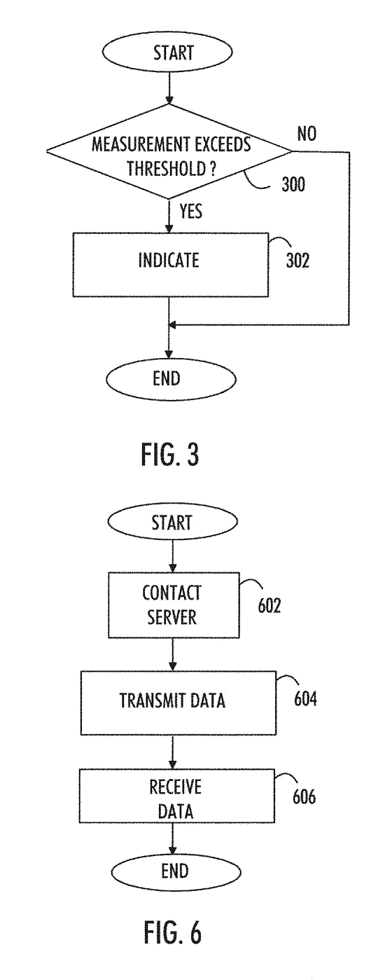

In an embodiment, in step 212, the apparatus is configured to show indications on the basis of one or more measurements. Indications are explained later in connection with FIG. 3.

In step 214, the apparatus is configured to detect that the water stops flowing in the pipe at a second time instant.

In step 216, the apparatus is configured to determine the amount of fluid that flowed through the pipe between the first and the second time instant and determine the temperature of the fluid between the first and the second time instant.

In step 218, the apparatus is configured to store the determined values and the time elapsed between the first and the second time instants as an entry in the memory.

In step 220, the apparatus is configured to control the transceiver to transmit the entry. The transmission may be performed directly after storing or several entries may be transmitted together at a later time instant. Communication with other devices is explained below in connection with FIGS. 4 and 6.

FIG. 3 illustrates an example of the use of indicators. The apparatus is measuring amount of water flowing through the apparatus and the time elapsed since the water started flowing. In an embodiment, the apparatus compares 302 the measurements to given thresholds, and if a threshold is exceeded an indication 304 is given using the indicators. For example, if water is flowing through the apparatus longer than a given time threshold T1, the processing unit may light a red LED to indicate to the user that he/she has spent a long time in the shower.

In an embodiment, more than one different indicator and threshold may be used. For example, the apparatus may comprise LEDS of different colours, such as red, yellow and green, for example. When user turns the shower on, a green LED is lit. When time passes and a given threshold T1 is exceeded green LED is put off and yellow LED is lit. When time elapsed since the beginning of the shower exceeds another threshold T2, yellow LED is put off and red LED is lit.

In an embodiment, the indicators may be a set of LEDs or lights, and each time a threshold is exceeded a new indicator is lit in addition to already lit indicators.

In an embodiment, indicators are lit when a threshold is exceeded multiple times. For example, first indicator is lit when a measured unit exceeds a threshold. When the measured unit exceeds the threshold multiplied by two, a second indicator is lit, and so on.

In an embodiment, the LEDs are situated near the nozzle in such a manner that the water flowing through the nozzle is coloured. In an embodiment, the LEDs may be in another part of the apparatus, or they may be located in more than one part of the apparatus.

In an embodiment, a sound from a speaker may be an indication. The sound may be music, speech or an alarm, for example.

In an embodiment, the indicator may be a unit configured to vibrate.

In an embodiment, the indicator may be a small monochrome or colour display.

The thresholds may be stored in the memory of the apparatus and they may be configurable.

Thus, the apparatus may give instant feedback to the user of the shower. The user may monitor the way he/she uses the shower and make changes if a reduction in the consumption is needed, for example.

As the apparatus may be connected at the place of a regular shower head, the installation is easy and can be done without any tools or professional help.

FIG. 4 illustrates an example of a communication environment of the apparatus. As mentioned above, the apparatus may comprise a wireless transceiver 122 operationally connected to the processing unit 116. The wireless transceiver 122 may be a Bluetooth® or Bluetooth® low energy (Bluetooth LE, BLE or Bluetooth Smart) transceiver or a Wireless Local Area Network (WLAN) transceiver based on IEEE 802.11 standard, for example. Any other transmission technology may also be used as well.

In an embodiment, the processing unit may control the transmitter to initiate communication with a transceiver external to the apparatus 100. The external apparatus or device the apparatus 100 is communicating with may basically be any apparatus or device comprising a suitable transceiver. The apparatus 100 may communicate with more than one external transceiver. The external apparatus or device 400, 402 may be a mobile phone, a tablet computer or a personal computer, a terminal equipment, a router or base station, for example.

For example, in Bluetooth® and WLAN technologies the transceivers may be configured to set up a connection whenever two transceivers paired together come to a common coverage area. Pairing means that both transceivers have stored parameters with which they can recognise each other for communication.

In an embodiment, the apparatus 100 is configured to transmit the entries stored in the memory of the apparatus to the external apparatus or device 400, 402. The transmission may be performed directly after storing or several entries may be transmitted together at a later time instant.

In an embodiment, the apparatus 100 is configured to receive data from the external apparatus or device 400, 402. The data may be the thresholds used in the control of the indicators, for example. In addition, other data related to the indicators may be received, such as sound or sounds to be played.

In an embodiment, the external device 400, 402 may be configured to communicate with one or more servers 406 located in a communication network such as the Internet, for example. The servers 406 may store the entries received from the apparatus 100 or contain data which may be utilised in the apparatus 100 or in the external device 400, 402.

The external device 400, 402 may be configured to process the data received from the apparatus 100. The external device may comprise suitable software configured to process and display data related to entries received form the apparatus 100. For example, the consumption of water and energy and costs related to the consumption of the water in the apparatus may be monitored. All data may be sent to the network server which may store the data and where the data may be further processed in needed.

For example, the external device may display daily, weekly or monthly values related to the consumption of water and energy and costs related to the consumption of the water in the apparatus. Thus, the user may in a detailed manner and during a long time span monitor the way he/she uses the shower and make changes if a reduction in the consumption is needed, for example. The costs related to the use of the shower are thus readily available.

The external device may fetch the parameters related to the costs of the amount of water and heating of the water from the server 406 or the parameters may be given by the user.

In an embodiment, the external device may upon installation of the software fetch default parameters on the basis of the location of the apparatus 100 or the external device 400, 402 from the server 406 and the user may provide more accurate parameters if need be.

In an embodiment, the external device comprises a location unit, such as a satellite positioning receiver (Global Positioning System, GPS or Globalnaja navigatsionnaja sputnikovaja sistema ttuis, GLONASS, for example) with which the device may determine the location of the device. The device may inform the location to the server, which on the basis on the location is configured to select information to be set to the device.

In different locations different parameters may be important. For example, in some countries water as such is freely available for a relatively low price, but generating warm water is expensive. In other countries water is an expensive resource but generating warm water is cheap.

No other external devices are needed in the process. The apparatus 100 itself functions as a shower head and the external device 400 may be the mobile phone, a tablet or a computer of the user. The use of the network server is optional as the user may type required parameters into the external device 400. The software for the external device 400, 402 may be loaded from a suitable application store.

In an embodiment, the external device 400 may provide the user or users of the apparatus incentives for limiting the use of water. For example, the external device 400 may offer virtual prizes if the consumption of water during a given time period is below a given thresholds or is smaller than during a previous corresponding time period.

In an embodiment, the apparatus 100 may configured to communicate with another similar apparatus 404. As explained below, the apparatus 100 may receive information on the total volume or capacity of the warm water storage in the facility the apparatus 100 is installed. Thus, the apparatus may be aware of the total amount of warm water available and the amount of warm water passed through the apparatus. If the apparatus is the only one using warm water, it may activate an indicator when the used amount of warm water approaches the capacity of the warm water storage in the facility. If there are more than one apparatus in the facility, the apparatuses may communicate with each other and exchange information about the used amount of warm water and the capacity of the warm water storage, for example.

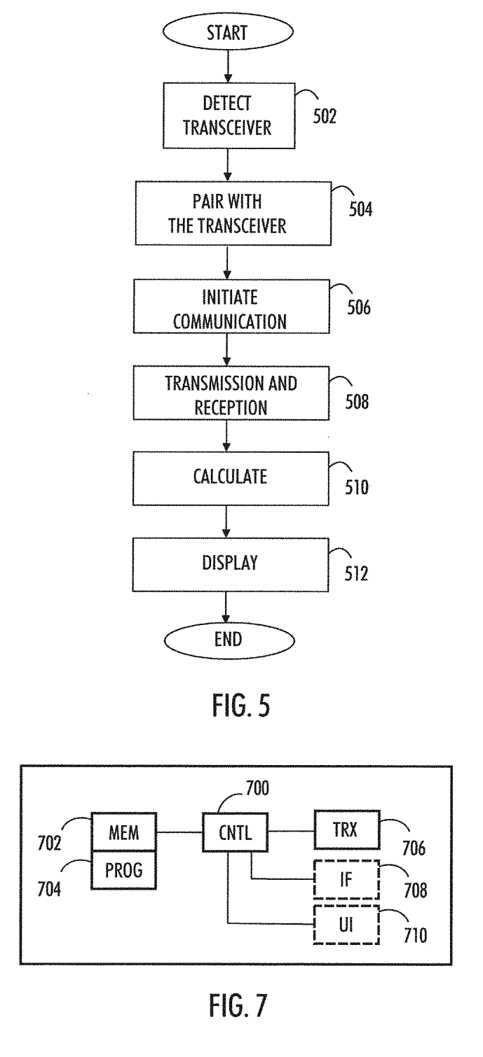

The flowchart of FIG. 5 illustrates the communication of the external apparatus or device 400, 402 with the apparatus 100.

In step 502, the external device 400, 402 is configured to detect the transceiver of the apparatus 100.

In step 504, the transceiver of the external device 400, 402 and the transceiver of the apparatus 100 are paired for communication. The steps 502 and 504 may be performed according to the communication technology used.

In step 506, the external device 400, 402 is configured to initiate communication with the apparatus 100.

In step 508, the external device 400, 402 is configured to receive data from the apparatus 100 and transmit data to the apparatus 100. For example, the external device may receive entries stored in the apparatus 200. The external device may transmit parameters such as thresholds to the apparatus. If there is no need to update the thresholds, it may be that the external device only receives data from the apparatus.

In an embodiment, the external device 400, 402 may be configured to transmit other data to the apparatus 100, such as the total volume or capacity of the warm water storage in the facility the apparatus 100 is installed. The external device 400, 402 may receive the information from the user of the apparatus, for example.

In an embodiment, in step 510, the external device 400, 402 is configured to obtain from a memory of the device information related to the costs of the consumption and heating of water and calculate values on the basis of the entries received from the apparatus 100 and the information. As mentioned above, the external device may calculate daily, weekly or monthly values for the consumption of water and energy in the apparatus and costs related to the consumption of the water in the apparatus 100.

In an embodiment, in step 512, the external device 400, 402 is configured to display the calculated values.

The flowchart of FIG. 6 illustrates the communication of the external apparatus or device 400, 402 with the server 406.

In step 602, the external device 400, 402 is configured to contact the server 406. The communication may utilise Internet Protocol or other suitable protocol known in the art. The communication may be encrypted.

In step 604, the external device 400, 402 is configured to transmit data received from the apparatus 100 to the server. The data may be the entries received from the apparatus 100 as such or it may be data processed by the external apparatus.

In step 606, the external device 400, 402 is configured to receive data from the server. The data may be data which may be utilised in the apparatus 100 or in the external device 400, 402. For example, the data may comprise the thresholds or information related to the costs of the consumption and heating of water. As mentioned, the external device 400, 402 may be configured transmit information on the location of the device to the server.

The data may comprise pricing information from the local water company. In addition, the data may comprise reference data related to general water or energy consumption. The reference data may be location specific. For example, the reference data may comprise average water consumption or average number of shower usage within a given time unit. The data received from the apparatus 100 may be compared to the reference data and displayed. This way the user may receive indication how the shower usage compares to reference data. The reference data may also comprise data related to environmental usage of water. For example the user may be given data how the amount of water and energy used in the shower relates to environment.

In an embodiment, the external device may communicate with more than one apparatus and gather data from more than one apparatus. This information may be processed in the external device or in a server. For example, in a facility comprising a large number of showers, such as a hotel, the usage of water in different hotel rooms may be easily monitored without any fixed installations in the water pipes.

In an embodiment, apparatuses 100 may be installed to all water taps and showers within a hotel room. Thus, the total amount water spent in the room may be monitored and stored in a server. This information may be used in billing or in a bonus system of the hotel, for example.

FIG. 7 illustrates an embodiment. The figure illustrates a simplified example of the external apparatus or device 400, 402. In some embodiments, the apparatus or device may be a mobile phone, a tablet, a personal computer or a router, or a part of such an apparatus.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 400, 402 of the example includes a control circuitry 700 configured to control at least part of the operation of the apparatus.

The apparatus may comprise a memory 702 for storing data. Furthermore the memory may store software 704 executable by the control circuitry 700. The memory may be integrated in the control circuitry.

The apparatus comprises one or more transceivers 706. The one or more transceivers are operationally connected to the control circuitry 700. They may be connected to an antenna arrangement (not shown). At least one of the transceivers 706 may be a Bluetooth® transceiver or a Wireless Local Area Network (WLAN) transceiver based on IEEE 802.11 standard, for example. IEEE refers to the Institute of Electrical and Electronics Engineers. Bluetooth® and WLAN are merely illustrative examples as any other transmission technology may also be used as well. The apparatus may also comprise a transceiver capable of communicating with cellular systems such as the universal mobile telecommunications system (UMTS) radio access network (UTRAN), long term evolution (LTE, known also as E-UTRA), long term evolution advanced (LTE-A), 5th generation mobile networks, and global system for mobile communication (GSM), for example.

The apparatus may further comprise interface circuitry 708 configured to connect the apparatus to other devices and network elements of communication system, for example to other corresponding apparatuses and networks. This applies especially if the apparatus is a computer or a router.

The apparatus may further comprise user interface 710 operationally connected to the control circuitry 700. The user interface may comprise a display, a keyboard or keypad, a microphone and a speaker, for example. This applies especially if the apparatus is a mobile phone, a tablet or a computer.

In an embodiment, the software 704 may comprise a computer program comprising program code means adapted to cause the control circuitry 700 of the apparatus to control the transceiver 706 to receive one or more entries, each entry comprising a time interval, an amount of fluid associated with the time interval and a temperature associated with the fluid, store the received one or more entries in the memory 702, obtain information related to the properties and pricing information of the fluid and energy consumption, and calculate for one or more entries an energy and/or price information value on the basis of a received and obtained information.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1-13. (canceled)

14. An apparatus connectable to the end of a pipe where water is flowing, the apparatus comprising:
a generator configured to generate electric power from the water passing through the generator and means for storing electricity generated by the generator,
a first sensor configured to measure the temperature of the water,
a processing unit and a memory operationally connected to the processing unit;
a wireless transceiver operationally connected to the processing unit; wherein
the processing unit is configured to receive power from the generator;
and the processing unit is configured to
detect that water starts flowing in the pipe at a first time instant on the basis of signal from the generator;
initiate after the detection
reception from the first sensor information on the temperature of the water,
determination of the amount of water flowing in the pipe from the amount of electricity generated by the generator, and
measurement of time elapsed since the first time instant;
detect that fluid stops flowing in the pipe at a second time instant on the basis of lack of signal from the generator;
calculate the total amount of fluid that flowed through the pipe between the first and the second time instant;
determine the temperature of the fluid between the first and the second time instant;
store the determined values and the time elapsed between the first and the second time instants as an entry in the memory;
control the transceiver to communicate with other corresponding apparatuses for exchanging information about the used amount of warm water; and
control the transceiver to transmit the entry to an external device.

15. The apparatus according to claim 14, the processing unit being further configured to
connect to a transceiver of the external device;
the control the transceiver to transmit one or more entries stored in the memory to the external device.

16. The apparatus according to claim 14, apparatus further comprising
one or more indicators;
the processing unit being configured to activate one or more indicators on the basis of determined information or when the time elapsed between the first and the second time instants exceeds a given threshold.

17. The apparatus according to claim 16, the processing unit being configured to receive via the transceiver given thresholds and store the thresholds in the memory.

18. The apparatus according to claim 14, the processing unit being configured to receive from the means for storing electricity information on the available power stored in the means for storing electricity and control the operation of the apparatus on the basis of the information.

19. The apparatus according to claim 14, the apparatus being removably connectable to a flexible pipe of a shower in the place of a shower head.

20. An apparatus, comprising:
at least one processor; and
at least one memory including computer program code,
the at least one memory and the computer program code configured to, with the at least one processor, cause the apparatus at least to perform:
control a transceiver to receive one or more entries, each entry comprising a time interval, an amount of water associated with the time interval and a temperature associated with the fluid;
store the received one or more entries in the memory;
determine the location of the apparatus based on a satellite positioning receiver and transmit information on the location to a network server;
receive from the network server location based information related to the properties and pricing information of the fluid and energy consumption; and
calculate for one or more entries an energy and/or price information value on the basis of a received and obtained information.

21. The apparatus according to claim 20, the apparatus being configured to transmit received entries to a network server.

22. A method for determining water consumption of water flowing through a pipe, the method comprising:
generating electric power with a generator connected to the pipe from water passing through the generator and storing the electricity, measuring the temperature of the water with a first sensor,
detecting that water starts flowing in the pipe at a first time instant on the basis of signal from the generator;
measuring the amount of water flowing in the pipe based on the amount of electricity generated by the generator;
measuring time elapsed since the water started continuously flowing through the pipe;
detecting that water stops flowing in the pipe at a second time instant on the basis of lack of signal from the generator;
determining the amount of water that flowed through the pipe between the first and the second time instant;
determining the temperature of the water between the first and the second time instant;
storing the determined values and the time elapsed between the first and the second time instants as an entry in a memory;
controlling the transceiver to communicate with other corresponding apparatuses for exchanging information about the used amount of warm water; and
controlling a transceiver to transmit the entry to an external device.

23. The method according to claim 22, further comprising:
connecting to a transceiver of the external device;
controlling the transceiver to transmit one or more entries stored in the memory to the external device.

24. A method, comprising:
receiving with a transceiver one or more entries, each entry comprising a time interval, an amount of water associated with the time interval and a temperature associated with the water;
storing the received one or more entries in a memory,
determining the location of the apparatus based on a satellite positioning receiver and transmit information on the location to a network server;
receiving from the network server location based information related to the properties and pricing information of the water and energy consumption, and
calculating for one or more entries an energy and/or price information value on the basis of a received and obtained information.

25. The method according to claim 24, further comprising: transmitting received entries to a network server.

26. A computer program product embodied on a distribution medium readable by a computer and comprising program instructions which, when loaded into an apparatus, execute a computer process according to the claim 24.

27. The apparatus according to claim 15, apparatus further comprising
one or more indicators;
the processing unit being configured to activate one or more indicators on the basis of determined information or when the time elapsed between the first and the second time instants exceeds a given threshold.

28. The apparatus according to claim 15, the processing unit being configured to receive from the means for storing electricity information on the available power stored in the means for storing electricity and control the operation of the apparatus on the basis of the information.

29. The apparatus according to claim 16, the processing unit being configured to receive from the means for storing electricity information on the available power stored in the means for storing electricity and control the operation of the apparatus on the basis of the information.

30. The apparatus according to claim 17, the processing unit being configured to receive from the means for storing electricity information on the available power stored in the means for storing electricity and control the operation of the apparatus on the basis of the information.

31. The apparatus according to claim 27, the processing unit being configured to receive from the means for storing electricity information on the available power stored in the means for storing electricity and control the operation of the apparatus on the basis of the information.

32. The apparatus according to claim 15, the apparatus being removably connectable to a flexible pipe of a shower in the place of a shower head.

33. The apparatus according to claim 16, the apparatus being removably connectable to a flexible pipe of a shower in the place of a shower head.
